(19) United States
(12) Patent Application Publication
(10) Pub. No.: US 2025/0274177 A1
(43) Pub. Date: Aug. 28, 2025

(54) METHOD AND ONE OR MORE NETWORK ENTITIES FOR IMPROVED UPLINK CHANNEL ESTIMATION

(71) Applicant: Telefonaktiebolaget LM Ericsson (publ), Stockholm (SE)

(72) Inventors: Yezi Huang, Taby (SE); Chenguang Lu, Sollentuna (SE); Miguel Berg, Sollentuna (SE)

(21) Appl. No.: 18/859,526

(22) PCT Filed: Apr. 26, 2022
(86) PCT No.: PCT/SE2022/050403

§ 371 Date: Oct. 23, 2024

(51) Int. Cl. H04B 7/06; H04L 25/02

(52) U.S. Cl. CPC H04B 7/0617; H04L 25/0224

(57) ABSTRACT

Disclosed is a method for improved uplink channel estimation of an uplink signal received at a network node (130) connected to a plurality of antennas (131, 132) from a wireless device (140, 141). The method determines whether to determine and use a channel estimation based on a demodulation reference signal, DMRS, received with the uplink signal or whether to use a stored channel estimate instead. The determination is performed based on one or more of a quality-related criterion of the stored channel estimated and a quality-related criterion of the DMRS-based channel estimate. Hereby, the most suitable channel estimate may be used, which results in better uplink channel estimations.

### TECHNICAL FIELD

The present disclosure relates generally to methods and network entities of a wireless communication network for improved uplink channel estimation. The present disclosure further relates to computer programs and carriers corresponding to the above methods and entities.

### BACKGROUND

In order to cater for the increasing demand of throughput in wireless communication networks, and especially over the air interface between a wireless device and a base station, aka network node, Multiple Input Multiple Output (MIMO) techniques have been developed. MIMO techniques have first been adopted to practice in Long Term Evolution (LTE), aka 4G. In MIMO, the network node has a large number of antenna branches for transmitting and receiving wireless signals, each antenna branch having at least one antenna element or, shortly, antenna. With the development of the base stations, more and more antennas are equipped at the base stations side, from 2 antennas to 64 antennas and even higher. Having more antennas benefits both single-user MIMO (SU-MIMO) and multi-user MIMO (MU-MIMO). It allows more user layers (e.g. 2, 4, 8, 16 or more layers) to be transmitted simultaneously using the same frequency and time resources by separating user layers spatially and therefore can significantly increase spectrum efficiency and cell capacity. When the number of antennas is much larger than the number of user layers, it is usually referred to as massive MIMO. For example, 64 antennas are used to serve 8 layers.

In MIMO techniques, the antenna elements are used for beamforming wireless signals to be transmitted and received. “Beamforming” means focusing the communicated signals in different directions. In this disclosure, focus is on the uplink (UL) MIMO system using frequency-domain beamforming techniques. Frequency-domain beamforming techniques may be based on e.g. zero-forcing (ZF), minimum mean square error (MMSE) or minimum mean square error-interference rejection combining (MMSE-IRC) methods. MMSE-IRC method is also referred to as interference rejection combining (IRC). In general, MMSE-IRC achieves better performance than the ZF and MMSE methods, since it mitigates both intra-cell and inter-cell interferences, also called co-channel interferences, from other cells.

FIG. 1 illustrates an UL MIMO receiver design of a base station based on a demodulation reference signal (DMRS) received in the UL signal. After cyclic prefix (CP) has been removed from the incoming signals in a CP removing unit 12 and the signals have been transformed from time domain to frequency domain by a fast Fourier transform (FFT) unit 14, the DMRS is extracted by a DMRS extraction unit 16. Thereafter, the communication channel is estimated in frequency domain in a channel estimation unit 18 based on the extracted DMRS. Then beamforming weights (BFWs) are calculated in a BFW calculation unit 20 based on the channel estimate. The calculated BFWs are used to perform UL beamforming in a beamforming unit 22 on the UL signal in frequency domain. The beamformed UL signal is then demodulated and decoded in a demodulation and decoding unit 24. As described previously, the algorithm for BFW calculation can be based on ZF, MMSE or MMSE-IRC etc. methods. Note that for the MMSE-IRC method the channel estimation part also calculates the covariance matrix of interference and noise, which is used in BFW calculation. As DMRS and data are multiplexed in each slot and thereby experience the same channel, using DMRS for channel estimation and beamforming can effectively mitigate the intra-cell interference, as well as the inter-cell interferences if MMSE-IRC method is used.

A base station that handles massive MIMO techniques is often realized as a distributed base station system comprising a Distributed Unit (DU) and a radio unit (RU). In a distributed base station system, base station functionality is split between the DU and the RU. The RU is connected to the DU via a fronthaul (FH) interface or link. The DU may also be referred to as baseband unit (BBU). The RU is connected to a plurality of antennas through which the RU wirelessly communicates with at least one wireless device. The DU is in its turn connected to other base station systems or base stations, and over a backhaul interface to a core network (CN) of the wireless communication system. The DU is centralized and there can be more than one RU connected to each DU. Traditionally, the DU performs advanced radio coordination features such as joint detection, joint decoding, coordinated multi-point transmission (CoMP), to increase the spectrum efficiency and network capacity, as well as baseband processing, whereas the RU performs radio frequency (RF) processing and transmission/reception of the RF processed signals. However, there are also suggestions on how to perform a split of the lower layer functionality between the RU and the DU, called different lower layer split (LLS) options. Three such LLS options that may be applied in the UL direction are shown in FIG. 1, called LLS1, LLS2 and LLS3. For LLS1, LLS2 and LLS3, function blocks on the left-hand side in FIG. 1 are implemented in the RU whereas function blocks on the right-hand side are implemented in the DU. In LLS example 1 and 2, the beamforming part (DMRS extraction, channel estimation, BFW calculation, and the performing of beamforming) are implemented in the DU. In LLS example 3, the beamforming part is implemented in the RU. Note that the BBU/DU and the RU are referred to as O-DU and O-RU, respectively, in O-RAN. In some terminologies, RU can be also referred to as remote radio unit (RRU). In eCPRI terminologies, BBU and RU are referred to as eCPRI Radio Equipment Control (eREC) and eCPRI Radio Equipment (eRE), respectively. In another terminology, BBU and RU may be referred to as LLS-CU and LLS-DU, respectively. The BBU and its equivalence can also be softwarized or virtualized as Baseband Processing Function in a Cloud environment. In the following, we use a general term of DU and RU, but use of those terms herein are not intended to limit the application of the innovation, which can be used in any suitable communication field.

The accuracy of the channel estimation has strong impact on beamforming performances. In prior art, DMRS received in the current slot is used for the UL channel estimation. Then the channel estimates are used for BFW calculation. The calculated BFWs are then used to perform the beamforming of the data symbols received in the same slot as the DMRS was received. However, it has been observed that on some occasions, the channel estimation accuracy based on the received DMRS is not very good. Consequently, there is a need of an improved handling of UL signals at the network node including an improved channel estimation accuracy.

### SUMMARY

It is an object of the invention to address at least some of the problems and issues outlined above. It is an object of embodiments of the invention to provide more accurate channel estimations for UL channels at a network node. It is another object to improve handling of UL signals for a network node capable of beamforming, and especially to improve UL channel estimation accuracy for handling UL signals for a network node capable of beamforming. It is possible to achieve these objects and others by using methods and network entities as defined in the attached independent claims.

According to one aspect, a method is provided that is performed by one or more network entities of a wireless communication network, the wireless communication network comprising a network node connected to a plurality of antennas. The method comprises determining, for individual of at least one user layer signal that is received at the network node in an UL signal, which UL signal comprises the at least one user layer signal of each of at least one user layer of a wireless device wirelessly connected to the network node (130), and a demodulation reference signal, DMRS for each user layer signal, whether to use for beamforming weight calculation, a channel estimate to be determined from the received DMRS or a stored channel estimate determined from a previously received reference signal of the individual user layer, the determination being based on one or more of: one or more quality-related criterion of the stored channel estimate and one or more quality-related criterion of the channel estimate to be determined from the received DMRS. Further, the method comprises, for individual of the at least one user layer, when it is determined to use the channel estimate to be determined from the received DMRS, determining the channel estimate from the received DMRS, and determining beamforming weights for frequency-domain beamforming based on the channel estimate determined from the received DMRS. Also, the method comprises, for individual of the at least one user layer, when it is determined to use the stored channel estimate, obtaining the stored channel estimate and determining beamforming weights for frequency-domain beamforming based on the stored channel estimate. Thereafter, the method comprises initiating frequency-domain beamforming of the received UL signal using the determined beamforming weights.

According to another aspect, one or more network entities is provided, which is configured to operate in a wireless communication network. The wireless communication network comprises a network node connected to a plurality of antennas. The one or more network entities comprises a processing circuitry and a memory. Said memory contains instructions executable by said processing circuitry, whereby the one or more network entities is operative for determining, for individual of at least one user layer signal that is received at the network node in an UL signal, which UL signal comprises the at least one user layer signal of each of at least one user layer of a wireless device wirelessly connected to the network node, and a DMRS for each user layer signal, whether to use for beamforming weight calculation, a channel estimate to be determined from the received DMRS or a stored channel estimate determined from a previously received reference signal of the individual user layer. The determination is based on one or more of: one or more quality-related criterion of the stored channel estimate and one or more quality-related criterion of the channel estimate to be determined from the received DMRS. The one or more network entities is further operative for determining, for individual of the at least one user layer, the channel estimate from the received DMRS, and for determining beamforming weights for frequency-domain beamforming based on the channel estimate determined from the received DMRS, when it is determined to use the channel estimate to be determined from the received DMRS. The one or more network entities is further operative for obtaining, for individual of the at least one user layer, the stored channel estimate and for determining beamforming weights for frequency-domain beamforming based on the stored channel estimate, when it is determined to use the stored channel estimate. Also, the one or more network entities is further operative for initiating frequency-domain beamforming of the received UL signal using the determined beamforming weights

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a schematic block diagram of a receiver of a wireless communication network according to prior art.

FIG. 2 is a schematic diagram of a wireless communication network in which the present invention may be used.

FIG. 3a is a diagram over time and frequency illustrating a first example of DMRS configuration and the four orthogonal antenna ports provided by this configuration.

FIG. 3b is a diagram over time and frequency illustrating a second example of DMRS configuration and the eight orthogonal antenna ports provided by this configuration.

FIG. 3c are two diagrams over time and frequency illustrating a third and a fourth example of DMRS configuration.

FIG. 4 is a flow chart illustrating a method performed by a network node, according to possible embodiments.

FIG. 5 is a schematic block diagram of a distributed base station system in which embodiments of the present invention may be used.

FIG. 6 is a schematic block diagram of a functional split of receiver functionality between an RU and a DU of a distributed base station system, according to embodiments.

FIG. 7 is a schematic block diagram of another functional split of receiver functionality between an RU and a DU of a distributed base station system, according to further embodiments.

FIG. 8 is a schematic block diagram of another functional split of receiver functionality between an RU and a DU of a distributed base station system, according to further embodiments.

FIG. 9 is a flow chart illustrating a method performed by an RU, according to possible embodiments.

FIG. 10 is a block diagram illustrating a network node in more detail, according to further possible embodiments.

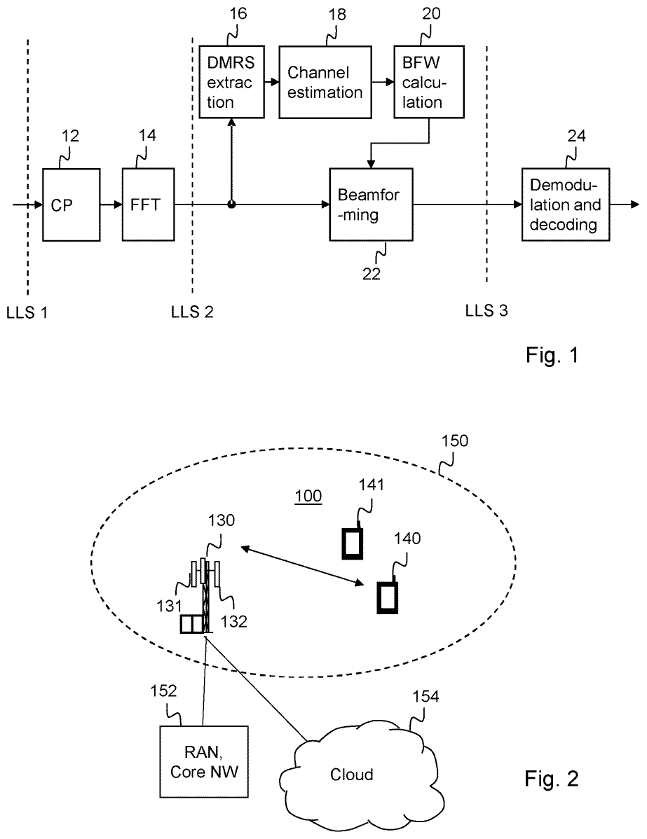

### DETAILED DESCRIPTION

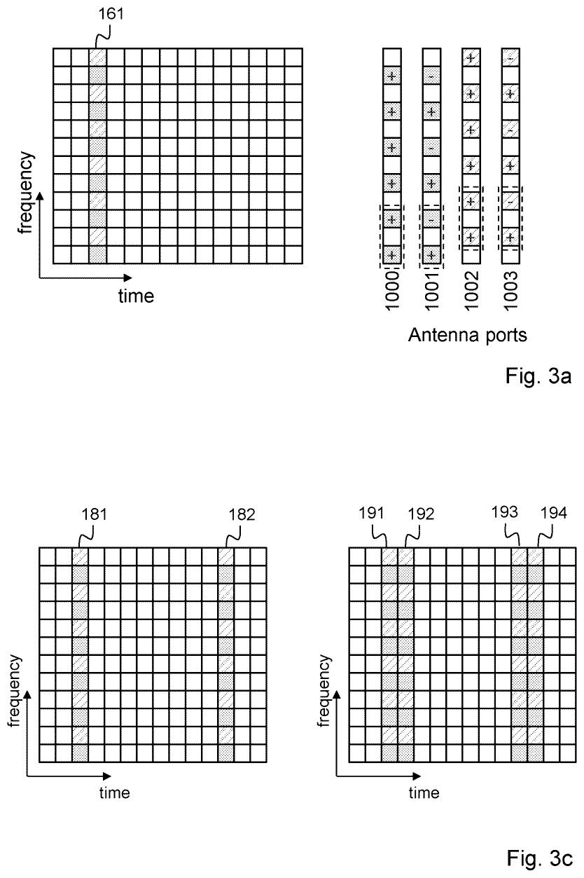

FIG. 2 shows a wireless communication network 100 comprising a radio access network (RAN) node aka network node 130 that is in, or is adapted for, wireless communication with one or more wireless communication devices aka wireless devices 140, 141. The network node 130 provides, or is adapted for providing, radio access in a cell 150 covering a geographical area. The network node 130 has a plurality of antennas 131, 132. The network node is capable of beamforming for directed communication with the wireless device(s) 140, 141. The network node 130 may further be connected to one or more other network nodes 152 of the wireless communication network, such as RAN nodes or core network nodes. The network node 130 may further be connected to a cloud-computing network 154.

The wireless communication network 100 may be any kind of wireless communication network that can provide radio access to wireless devices. Example of such wireless communication networks are networks based on Global System for Mobile communication (GSM), Enhanced Data Rates for GSM Evolution (EDGE), Universal Mobile Telecommunications System (UMTS), Code Division Multiple Access 2000 (CDMA 2000), Long Term Evolution (LTE), LTE Advanced, Wireless Local Area Networks (WLAN), Worldwide Interoperability for Microwave Access (WiMAX), WiMAX Advanced, as well as fifth generation (5G) wireless communication networks based on technology such as New Radio (NR), and any possible future sixth generation (6G) wireless communication network.

The network node 130 may be any kind of network node that can provide wireless access to a wireless device 140 alone or in combination with another network node. Examples of network nodes 130 are a base station (BS), a radio BS, a base transceiver station, a BS controller, a network controller, a Node B (NB), an evolved Node B (eNB), a gNodeB (gNB), a Multi-cell/multicast Coordination Entity, a relay node, an access point (AP), a radio AP, a radio unit (RU), a remote radio head (RRH) and a multi-standard BS (MSR BS).

The one or more wireless devices 140, 141 may be any type of device capable of wirelessly communicating with a network node 130 using radio signals. For example, the one or more wireless devices 140, 141 may be a User Equipment (UE), a machine type UE or a UE capable of machine to machine (M2M) communication, a sensor, a tablet, a mobile terminal, a smart phone, a laptop embedded equipped (LEE), a laptop mounted equipment (LME), a USB dongle, a Customer Premises Equipment (CPE), an Internet of Things (IoT) device, etc.

In prior art, a DMRS received in the current slot is used for the UL channel estimation of the channel for a certain user layer, which user layer signal is sent in the same slot as the DMRS. Then the channel estimate is used for BFW calculation. The calculated BFWs are then used to perform the beamforming of the data symbols received in the same slot as the DMRS was received. However, it has been observed that on some occasions, the channel estimation accuracy based on the received DMRS is not very good. One such occasion is when the number of orthogonal DMRS ports supported by the DMRS configuration is smaller than the number of scheduled user layers in the received UL signal. The reason is that then at least two of the user layers need to use DMRS signals that are mutually non-orthogonal and mutually non-orthogonal DMRS signals used in the same time slot lead to interferences between the at least two DMRS signals and therefore poor channel estimates.

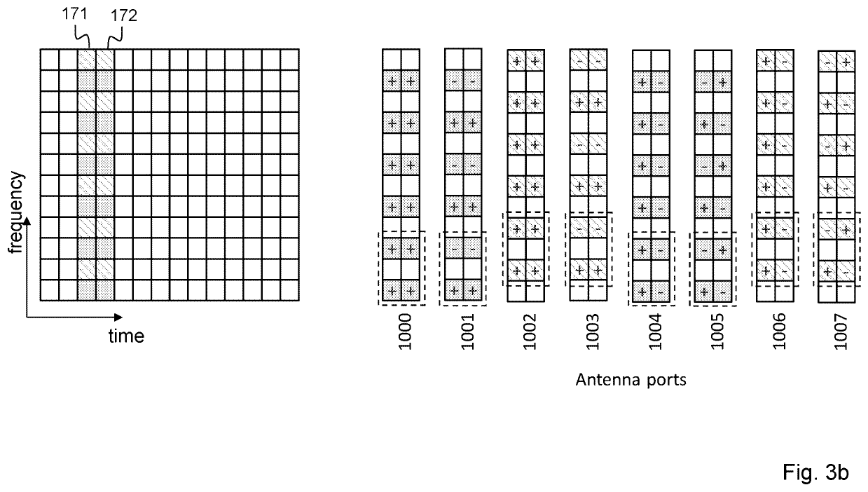

In NR, the number of available orthogonal DMRS ports depends on the DMRS configurations—for configuration type 1, at most 8 orthogonal ports are supported and for configuration type 2, at most 12 orthogonal ports are supported. Out of 14 symbols of one slot, 1-4 symbols can be used for DMRS transmission depends on the configuration. FIG. 3a shows one configuration example of Type 1 single-symbol DMRS with 4 orthogonal antenna ports using 1 DMRS symbol 161. FIG. 3b shows one configuration example of Type 1 double-symbol DMRS with 8 orthogonal ports using 2 DMRS symbols 171, 172. To obtain accurate channel estimates for more than 4 user layers, we need to use double-symbol DMRS configuration. Using double-symbol DMRS, however, also doubles the overhead (OH) of DMRS comparing to single-symbol DMRS configuration, since the symbols occupied by DMRS cannot be used to carry user data. In the examples of FIG. 3a and FIG. 3b, the OH are 1/14 and 1/7, respectively, considering 14 symbols in a slot in NR. FIG. 3c shows two other examples with 2 DMRS symbols 181, 182 and 4 DMRS symbols 191, 192, 193, 194, respectively, where one additional DMRS occasion are used. In these two cases, the OH are increased to 1/7 and 2/7, respectively. This additional DMRS occasion is usually needed to track the channel and interference variation within a slot due to mobility, to track the frequency offsets within a slot, as well as to track the phase noise. Therefore, for 8 user layers, double-symbol configuration using 4 DMRS symbols, as shown in the right diagram of FIG. 3c, should be used to support 8 orthogonal ports and to support tracking of channel variation, frequency offset and phase noise. This would increase the DMRS overhead to 28.6% or 2/7. The high OH may be justified when 8 or more layers are served simultaneously which leads to higher spectrum efficiency. However, this configuration would create unnecessary OH when fewer than or equal to 4 layers are scheduled for medium to low traffic load.

From the above discussion, using (semi-)static DMRS configuration is not optimal in different circumstances. When traffic load is from medium to low, using a DMRS configuration supporting more orthogonal ports (e.g. 8 ports) would limit the peak UE throughput due to unnecessary DMRS OH. When traffic load is high, using a DMRS configuration supporting fewer orthogonal ports would degrade the MU-MIMO performance potential, though the DMRS overhead is lower. The reason is that the Signal to Interference and Noise Ratio (SINR) on each resource element (RE) is reduced due to degraded channel estimation quality and thereby fewer bits can be carried by these REs. The reduced overhead is not enough to compensate this loss. When the SINR between non-orthogonal antenna ports is sufficiently high, e.g. using beam selection per layer to reduce the interferences from non-orthogonal ports, there can still be a throughput gain comparing to scheduling fewer layers, e.g. 4 layers, using orthogonal antenna ports, though the throughput can be much lower than if more orthogonal antenna ports are used with more DMRS OH. In 3GPP, it is possible to change the DMRS configuration regarding the number of orthogonal ports via Radio Resource Control (RRC) signaling. But the RRC process is quite slow, which is not an effective solution to adapt to scheduling changes.

Furthermore, out of different combinations of configuration type and single or double symbol, only part of them have mandatory support from the user equipment (UE) perspective. For example, for configuration type 1, only single-symbol DMRS with one DMRS occasion per resource block and slot as in FIG. 3a is mandatory while double-symbol DMRS with up to 8 orthogonal DMRS ports as in FIG. 3b is optional. Also, as shown in FIG. 3c, using two DMRS occasions per resource block is an alternative, either single-symbol as in the left diagram of FIG. 3c or double-symbol as in the right diagram of FIG. 3c are alternatives, however, they are also only optional. In practice, DMRS configuration supporting 4 orthogonal ports is usually used which fully supports SU-MIMO of four receiving antennas and four transmitting antennas (4T4R) and achieves the peak rate of SU-MIMO. This UE support limitation also causes that today's wireless communication network is only configured with 4 orthogonal ports. In this case, MU-MIMO with more than 4 layers can only be done by carefully scheduling the UEs with low mutual interferences. For example, 8-layer MU-MIMO can be performed by forming two 4-layer MU-MIMO groups. The performance is, however, much worse than if it is performed as one 8-layer group (assume channel estimation with 8 orthogonal ports), because the interferences between two groups are not explicitly mitigated and the channel estimation is less accurate due to non-orthogonal DMRS used between two groups. The possibility to schedule various UEs together is also reduced since only the groups of UEs with low mutual interferences can be scheduled together. This would limit the usage of the higher order MU-MIMO.

Sounding reference signal (SRS) can also be used for channel estimation. According to 3GPP TS38.211, V16.7.0, Table 6.4.1.4.2-1, up to 12 orthogonal ports can be supported by one set of SRSs based on the configured transmission comb and thereby the maximum number of cyclic shifts. However, comparing to DMRS, which is embedded in each slot together with data symbols, the interval between SRS occasions is longer. For periodic SRS, the periodicity can be in the range of 2-320 ms. Using channel estimates based on SRS may suffer from a channel aging issue and is thereby not suitable for high mobility scenario. Aperiodic SRS can be scheduled on demand, which has lower overhead than periodic SRS and therefore has higher SRS capacity supporting more UEs.

According to an embodiment of this invention, a method is presented to dynamically determine whether to perform channel estimation for a received user layer signal based on the DMRS that is received in the same slot as the user layer signal or to use channel estimates based on previously received reference signals, which can be for example a DMRS or an SRS. The determination of whether to use channel estimates based on the current DMRS or stored channel estimates based on the previous reference signal can be based on, but not limited to, the number of co-scheduled user-layers, the timeliness and quality of the existing channel estimates, and mobility scenario. According to an embodiment, in which a distributed base station comprising a DU and an RU is used, the RU receives indicative control information from the DU. Based on the received information, the RU determines whether to perform the channel estimation using the incoming DMRS or to use channel estimates based on the previous reference signals, which channel estimates have been stored, e.g., in a channel state memory. If an estimation of interference plus noise (IpN) is also needed for certain beamforming algorithms, the network node further determines whether to use the DMRS or the SRS in addition to the determined channel estimates to obtain residual signals which represent the components of the interference and noise. In one embodiment in which a distributed base station is used, the DMRS/SRS-based channel estimation is done in the RU. In another embodiment, the SRS-based channel estimation is done in the DU and then the channel estimates are sent from the DU to the RU. In another embodiment, the DMRS/SRS-based channel estimation is done in the DU and is then sent from the DU to the RU. Then the channel estimates which adapt to the transmission scenario and optionally the residual signals are used to calculate BFWs for UL frequency-domain beamforming.

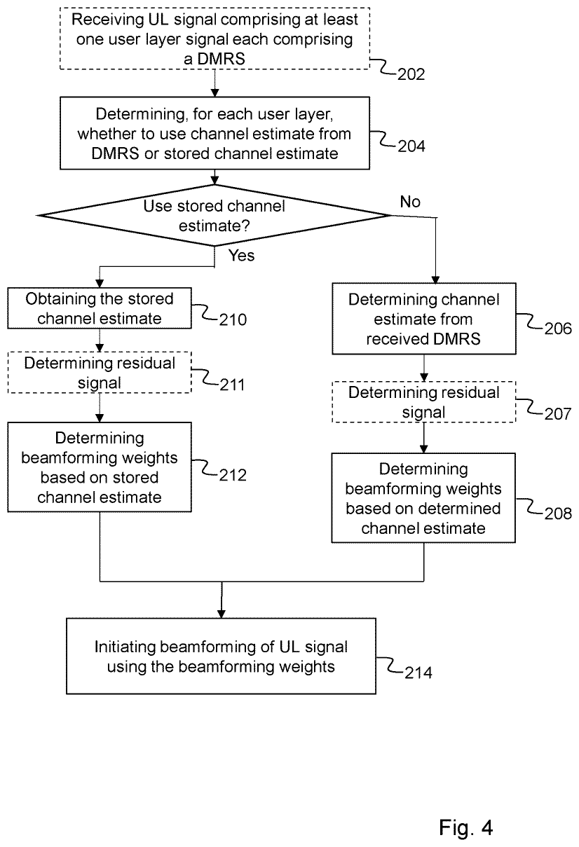

FIG. 4, in conjunction with FIG. 2, describes a method performed by one or more network entities of a wireless communication network 100. The wireless communication network comprises a network node 130 connected to a plurality of antennas 131, 132. The method comprises determining 204, for individual of at least one user layer signal that is received at the network node 130 in an UL signal, which UL signal comprises the at least one user layer signal of each of at least one user layer of a wireless device 140, 141 wirelessly connected to the network node 130, and a DMRS for each user layer signal, whether to use for beamforming weight calculation, a channel estimate to be determined from the received DMRS or a stored channel estimate determined from a previously received reference signal of the individual user layer, the determination being based on one or more of: one or more quality-related criterion of the stored channel estimate and one or more quality-related criterion of the channel estimate to be determined from the received DMRS. Further, for individual of the at least one user layer, when it is determined to use the channel estimate to be determined from the received DMRS, determine 206 the channel estimate from the received DMRS, and determine 208 beamforming weights for frequency-domain beamforming based on the channel estimate determined from the received DMRS. Also, for individual of the at least one user layer, when it is determined to use the stored channel estimate, obtain 210 the stored channel estimate and determine 212 beamforming weights for frequency-domain beamforming based on the stored channel estimate. Thereafter, initiating 214 frequency-domain beamforming of the received UL signal using the determined 208, 212 beamforming weights.

The one or more network entities 600 that performs the method may be realized at or in the network node 130 that receives the UL signal. Alternatively, the one or more network entities 600 may be arranged at or in any other network node of the wireless communication network 100. Alternatively, and as mentioned further down, the one or more network entities may be arranged at or in a DU or an RU of a distributed base station system. Still alternatively, the one or more network entities 600 may be realized as a group of network nodes, wherein functionality of the one or more network entities 600 is spread out over the group of network nodes. The group of network nodes may be different physical, or virtual, nodes of the network, which may be situated in a cloud-computing network, such as the network shown as 154 in FIG. 2. This alternative realization may be called a cloud-solution. In case the one or more network entities is realized in the network node 130 or the RU, the method further comprises the step of receiving 202 the UL signal comprising the user layer signal of each of at least one user layer and the DMRS for each user layer signal. Also, in the same case, the step of initiating 214 the beamforming signifies to actually perform the beamforming. In case the one or more network entities is realized in a DU of a distributed base station or as a cloud-solution, the one or more network entities can be informed by the network node/RU of any necessary information it may need for performing the method, such as information of the DMRSs. Also, in the same case, the one or more network entities initiates beamforming by instructing the network node/RU to perform beamforming using the determined beamforming weights. Also, the network node/RU may be informed of the determined beamforming weights.

Different channel estimations are needed for different user layers irrespective to which wireless device the user layer belongs. If there is only one user layer in the UL signal, it could still be of interest to determine whether to use an old or new channel estimate for this user layer, if for example the new channel estimate is based on narrow bandwidth DMRS and the old channel estimate is based on SRS, which uses whole bandwidth. However, the benefit of determining whether to use an old or new channel estimate normally becomes higher when there is a plurality of user layers in the UL signal. A “user layer” of an UL signal is one flow or stream of user data over dedicated communication resources from one wireless device to the network node. One wireless device may have one or multiple user layers. The user layer comprises a flow of user layer signals, sent on different occasions over the dedicated communication resources. Also, a DMRS is sent for each user layer signal. The DMRS is normally sent on another resource element than the user layer signal but in the same time slot. In other words, the received UL signal received at one occasion comprises one or more user layer signals that belong to different user layers. Herein, a DMRS for such a user layer signal is analyzed, or more exactly, a quality-related criterion of a channel estimate based on the DMRS and/or a quality-related criterion of a stored channel estimate for a previous reference signal, i.e., received at an earlier occasion is/are analyzed. The determining 204, for individual of the at least one user layer signal, whether to use the new channel estimate based on the DMRS received together with UL signal or the stored channel estimate signifies that it may be determined to use new channel estimates for some user layers and stored channel estimates for some user layers. However, it may also be possible to use new channel estimates for all user layers or old channel estimates for all user layers The previously received reference signal may be a DMRS or an SRS.

A quality-related criterion of the stored channel estimate may be for example when the stored channel estimate was determined, i.e. how long time it was since the stored channel estimate was determined, the shorter, the higher quality. A quality-related criterion of the channel estimate to be determined from the received DMRS could be the number of current co-scheduled user layer signals compared to the DMRS configuration; if the number of co-scheduled user layers is higher than the number of orthogonal ports the current DMRS configuration can support or the number of orthogonal ports the current DMRS uses, the quality is degraded. A quality-related criterion of the stored channel estimate may be, when DMRS was used for determining the stored channel estimate, the number of co-scheduled user layer signals compared to the DMRS configuration. Another quality-related criterion of the stored channel estimate may be mobility of the wireless device sending the user layer signal, e.g. the higher mobility the worse is the stored channel estimate. Another quality-related criterion of the stored channel estimate may be mobility of other wireless devices in other cells, the higher mobility the more the interference level may change, and the worse the stored channel estimate. Another quality-related criterion of the channel estimate to be determined from the received DMRS could be the bandwidth of the DMRS. If the user layer data only use a few resource blocks (RBs), the DMRS will only span the same number of RBs. The channel estimation performance using the DMRS with low bandwidth is lower than a channel estimation performance based on larger bandwidth, because of lower processing gain in the channel estimation processing. In this case, if the stored channel estimate is based on a larger bandwidth reference signal, it can be determined to use the stored channel estimate instead of the new one. This may be the case if the previously received reference signal was an SRS, as the SRS usually uses the full carrier bandwidth. The above-mentioned criteria may be mixed so that more than one of them are used for determining whether to use the stored channel estimate or a channel estimate to be determined from the received DMRS.

Beamforming is performed 214 of the mixed UL signal received 202 at the network node that comprises the at least one user layer signal. “Beamforming” when used herein e.g., means a technique that combines the UL signals in frequency domain received from the plurality of antennas with different complex-valued weights. The combining can improve signal quality of the wanted signals by focusing the reception to some directions where the wanted signals come from and reduce the interferences by forming nulling in certain directions where interference come from. The received signal from each antenna comprises at least one user layer signal component. “Component” is here used to explain that one received signal at an antenna may comprise multiple user layer signal components, each of which corresponds to one user layer. The stored channel estimate was determined and stored by the one or more network entities at an earlier occasion, for example in response to receiving the previous reference signal. Alternatively, the previous reference signal was stored at the earlier occasion so that it can be used for determining the channel estimate of the previous reference signal if it is needed later, for example when determining 204 to use the stored channel estimate. In this example, the term “stored” in “stored channel estimate” should be understood as storing information of a channel estimate of the previous reference signal.

By the above-mentioned method, it is possible select the best channel estimate, i.e. the most accurate channel estimate depending on receiving conditions and other quality-related criteria of a channel estimate based on the DMRS sent together with the UL signal compared to a channel estimate based on a previous reference signal that was received earlier. With more accurate channel estimates, the performance and capacity of the wireless communication network will increase. Also, when it is determined to use the stored channel estimate instead of determining a new one, also capacity of the one or more network entities is spared as no new channel estimate needs to be determined.

According to an embodiment, the one or more quality-related criterion of the stored channel estimate comprises one or more of: number of co-scheduled user layer signals when the stored channel estimate was determined, DMRS configuration when the stored channel estimate was determined in case DMRS was used then, SRS configuration when the stored channel estimate was determined in case SRS was used then, bandwidth of the previously received reference signal, mobility of the wireless device sending the user layer signal, mobility of other wireless devices in other cell(s) and variation of interference from other cell(s), and the one or more quality-related criterion of the channel estimate to be determined from the received DMRS comprises one or more of number of co-scheduled user-layer signals of the received UL signal, DMRS configuration of the received UL signal, bandwidth of the DMRS signal. “When the stored channel estimate was determined” signifies the time difference between the receiving of the UL signal and the receiving of the previously received reference signal. Generally, the shorter the time difference, the higher the quality of the stored channel estimate.

According to another embodiment, it is determined 204 for the individual of the at least one user layer signal to use the stored channel estimate for the beamforming weight calculation when a number of co-scheduled user-layer signals of the received UL signal is higher than a number of supported orthogonal ports of the DMRS configuration of the received UL signal.

In this case, the quality-related criteria of the channel estimate to be determined from the received DMRS are the number of co-scheduled user layer signals in relation to the number of supported orthogonal ports by the DMRS configuration. The number of supported orthogonal ports of the DMRS configuration should be interpreted as number of orthogonal ports used in the DMRSs of the received UL signal. When the number of co-scheduled user layer signals are higher than the number of supported orthogonal ports, it is determined to use the stored channel estimate instead of the channel estimate to be determined from the received DMRS. This is as when the number of co-scheduled user-layer signals are higher than the number of orthogonal ports of the DMRS configuration it means there is typically high interference between the DMRS signals, and then the channel estimate to be determined from the received DMRS will have a degraded quality. It is still possible to also cater for a quality-related criteria of the stored channel estimate. For example, if the previously received reference signal was a DMRS, it may need to be checked whether the number of co-scheduled user-layer signals for the previously DMRS was lower than the number of supported orthogonal ports. If the number of co-scheduled user-layer signals was higher than the number of orthogonal ports the new DMRS is probably better anyhow. Alternatively, it may be checked whether the previously received reference signal was an SRS because then the stored channel estimate is probably better than the new one. Two other quality-related criteria that may be taken into consideration together with the co-scheduled user layer signals and number of supported orthogonal ports are time since the stored channel estimate was determined together with the mobility of the wireless device. If it was a very long time since the previously received reference signal was received and the wireless device has moved a lot since then, it may still be advantageous to determine and use the channel estimate to be determined from the received DMRS instead of the stored channel estimate.

According to another embodiment, it is determined 204 for the individual of the at least one user layer signal to use the channel estimate to be determined from the received DMRS for beamforming weight calculation when one or more of the following apply: a time difference between the receiving of the UL signal and receiving of the previously received reference signal is higher than a first threshold, and a mobility of the wireless device 140, 141 from which the user layer signal was received is higher than a second threshold. In this case, the quality-related criteria of the stored channel estimate are the mobility of the wireless device and/or a criterion of how old the stored channel estimate. Here it is determined to use the received DMRS of the UL signal for determining the channel estimate instead of using the stored channel estimate when it can be determined that the mobility conditions of the wireless device have changed a lot since the stored channel estimate was determined. Also, the interference situation may be taken into consideration here.

According to one variant of this embodiment, the feature “time difference” may be when the time difference between the receiving of the UL signal and the receiving of the previously received reference signal is higher than the first threshold, which first threshold is determined by estimated mobility of the wireless device. I.e. the higher the mobility, the lower the time difference threshold. The mobility can be estimated using doppler shift estimated from the received reference signals. The doppler shift can be used to calculate coherence time during which the channel is considered correlated. In one example, if the time difference is longer than the coherence time calculated, the store channel estimate can be considered too old.

According to another embodiment, it is determined 204 for the individual of the at least one user layer signal to use the stored channel estimate when number of Resource Blocks, RBs, or number of subcarriers carrying user layer data of the user layer signal and the DMRS is smaller than a threshold. When this occurs, the channel estimation using the DMRS will be affected. The reason is that more processing gain can be achieved in channel estimation if more bandwidth is used. With only a few RBs or subcarriers, the processing gain is smaller and thereby affect the channel estimate quality. Especially, if the stored channel estimate was based on a wider bandwidth, e.g., SRS normally uses full carrier bandwidth, the quality is normally much better than that using the channel estimate from the received DMRS. This is especially useful for small data packets, e.g., in IoT traffic in massive Machine-Type Communication (MTC) and critical MTC.

According to yet another embodiment, when it was determined to use the stored channel estimate, also determining 211 a residual signal for interference rejection based on the received DMRS and the stored channel estimate, and wherein the beamforming weights for frequency-domain beamforming are determined 212 based on the determined 211 residual signal as well as on the obtained 210 stored channel estimate.

The residual signal can be obtained as z=y−Hx, where y is the received UL signal, H is a channel estimate and x is the reference signal. According to prior art, H is determined from the received DMRS, and x is the received DMRS. In this embodiment, H can be determined based on the stored channel estimate while x is the currently received DMRS. According to another embodiment, both H and x are based on the previously received reference signal.

According to yet another embodiment, when it was determined to use the stored channel estimate for one of the at least one user layers, compensating 216, after the frequency-domain beamforming of the received UL signal have been performed 214, for a phase shift caused by a phase difference between a previous channel that the previous reference signal experienced and a current channel that the user layer signal experiences, the phase-shift compensation being based on the beamformed DMRS of the one of the at least one user layer.

When performing the frequency-domain beamforming of the received UL signal, the DMRS of the received UL signal will naturally also be beamformed. The compensating 216 is then performed based on the beamformed DMRS signal of the user layer for which the stored channel estimate is used. The compensation may be performed based on a new channel estimation that uses the beamformed DMRS for estimating an effective channel WH, where W is the beamforming weights and H is the radio channel. Such an effective channel contains phase jump terms, i.e. the phase shift, which can then be compensated for. The phase shift compensation may be performed by an equalizer.

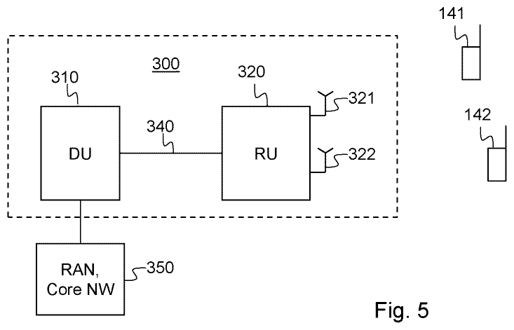

According to yet another embodiment, which refers to FIG. 5, the network node is a radio unit (RU) 320 of a distributed base station system 300 comprising the RU and a distributed unit (DU) 310 connected to the RU 320 via a fronthaul connection 340, which may be e.g., a point-to-point connection or a network, e.g., an Ethernet network. Here the one or more network entities is situated in the RU 320. In addition, the RU 320 sends the beamformed frequency-domain UL signal to the DU 310. The DU then demodulates and decodes the beamformed UL signal it receives from the RU. The RU 320 here comprises a plurality of antennas 321, 322 similar to the antennas 131, 132 of the network node shown in FIG. 2. The DU 310 is in FIG. 5 also connected to further network nodes 350 such as nodes of the core network and other radio access network nodes.

According to an alternative of this embodiment, the method further comprises receiving control information from the DU 310, the control information instructing the RU 320 whether to use for the beamforming weight calculation, the channel estimate to be determined from the received DMRS or the stored channel estimate. The received control information may either be the one or more quality-related criterion, or it could be an indication of which channel estimate to use.

According to another embodiment, the network node is a DU 310 of a distributed base station system 300 comprising the DU and an RU 320 connected to the DU 310 via a fronthaul connection 340. Here, the one or more network entities 600 are arranged on the DU 310. The DU 310 is then connected to the plurality of antennas via the RU 320, i.e., it is the RU that has the antennas. The RU 320 receives the UL signal comprising a user layer signal of each of the one or more user layers from its antennas, handles the UL signal in radio frequency and sends the UL signal further to the DU, whereby the DU receives 202 the UL signal comprising the user layer signal of each of the one or more user layers. Except for the steps of any of the above embodiments, the DU may also demodulate and decode the UL signal after performing the beamforming.

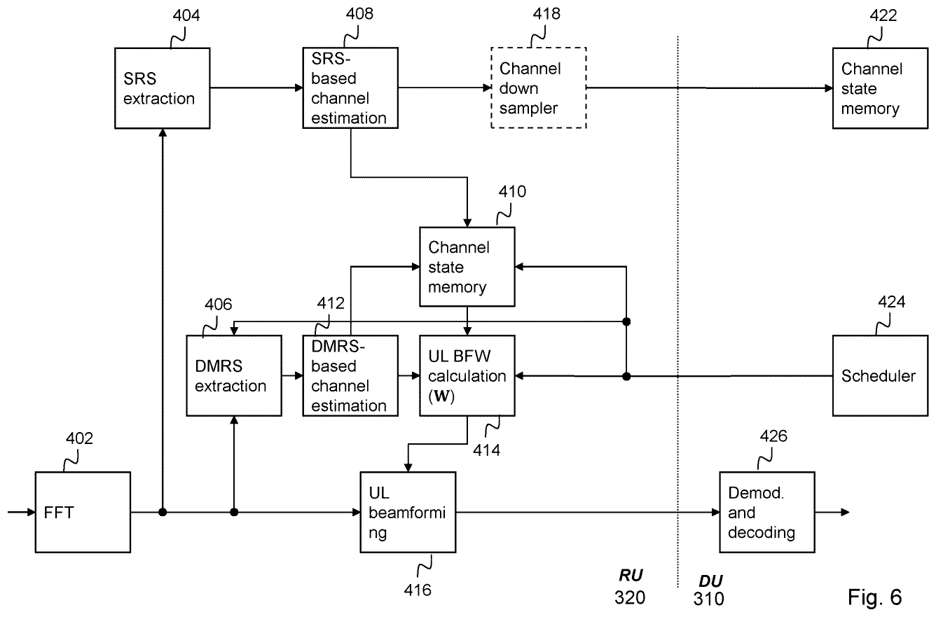

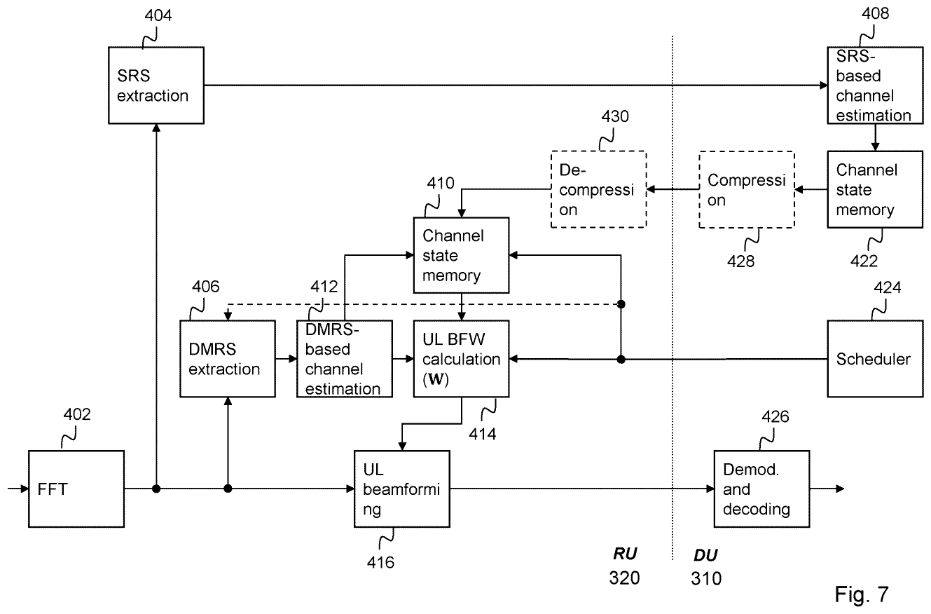

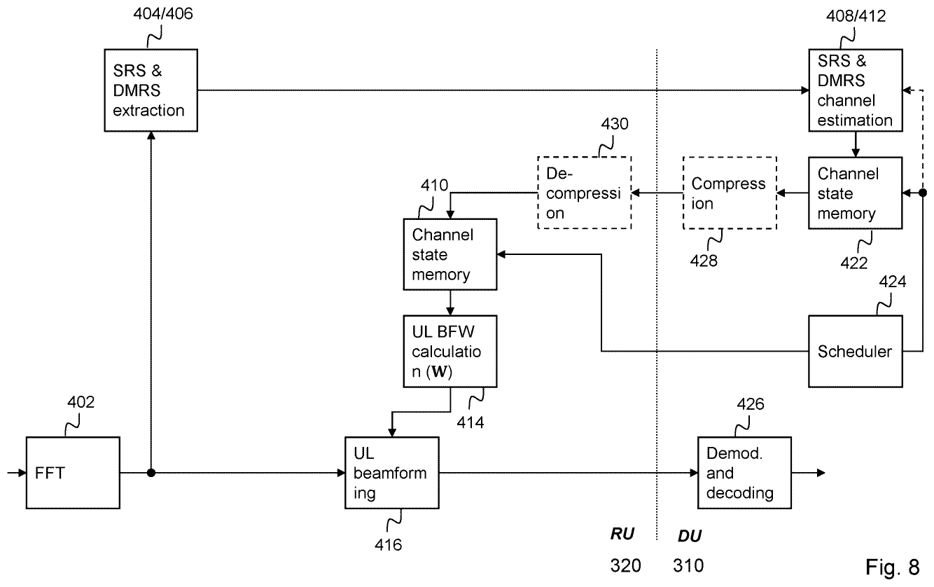

In the following different embodiments are shown for a distributed base station system 300 as described in FIG. 5. FIG. 6 shows an UL system block diagram of a first embodiment when both DMRS and SRS-based channel estimation are conducted in the RU 320. FIG. 7 shows an UL system block diagram of a second embodiment when the SRS-based channel estimation is conducted in the DU 310 while DMRS-based channel estimation is conducted in the RU 320. FIG. 8 shows an UL system block diagram of a third embodiment when both DMRS and SRS-based channel estimation are conducted in the DU 310. The first embodiment of FIG. 6 seems to be a preferable use case. The main reason is that to utilize the previous channel estimates to improve the performance comparing to using non-orthogonal DMRS, the frequency-domain granularity of the existing channel estimates is expected to be high, e.g., to be comparable to what can be obtained from the incoming DMRS. If the associated channel estimation is done by the DU 310, transporting such channel estimates from the DU 310 to the RU 320 over the fronthaul connection 340 (FIG. 5) significantly increases the fronthaul load. If lower frequency-domain granularity of channel estimates is provided, interpolation in frequency domain is needed to compensate for the granularity. If both DMRS and SRS based channel estimates are available for the same user layer on the same subcarriers, the one with better quality will be stored for later use. The channel estimate may be stored in a channel state memory.

The RU 320 of the UL system of FIG. 6 comprises an FFT unit 402 for transforming an incoming UL signal from time domain into frequency domain, an SRS extraction unit 404 for extracting an SRS from the frequency-domain incoming signal and a DMRS extraction unit 406 for extracting DMRS from the frequency-domain incoming signal. The RU 320 further comprises an SRS-based channel estimation unit 408 for determining a channel estimate of the extracted SRS and a first channel state memory 410 for storing the determined SRS-based channel estimate for possible later use. The RU 320 further comprises a DMRS-based channel estimation unit 412 for determining a channel estimate of the extracted DMRS. The channel estimate of the DMRS may be stored in the channel state memory 410 for later use, as for the SRS. The RU 320 further comprises an UL BFW calculation unit 414 for calculating BFWs based on either a stored channel estimation stored in the channel state memory 410 or a channel estimation based on the current DMRS signal, which then is received directly from the DMRS-based channel estimation unit 412. The RU 320 further comprises an UL beamforming unit 416 for beamforming the frequency-domain UL signal using the BFW determined by the UL BFW calculation unit 414. The DU 310 comprises a second channel state memory 422 in which the SRS-based channel estimation determined by the SRS-based channel estimation unit 408 can be stored, according to an alternative. Also, the RU 320 may have a channel down sampler 418 for sampling down the SRS-based channel estimation before sending it over the fronthaul connection to the DU 310 for storing at the second channel state memory 422. The DU 310 further has a scheduler 424. The scheduler 424 is arranged to send instructions to the RU 320 whether to use the stored channel estimation for the UL beamforming or whether to determine and use a DMRS-based channel estimation determined from the current DMRS. The instructions may be sent to the DMRS extraction unit 406, the first channel state memory 410 and/or the UL BFW calculation unit 414. Lastly, the DU 310 has a demodulating and decoding unit 426 for demodulating and decoding beamformed UL signals received over the fronthaul connection from the UL beamforming unit 416 of the RU 320.

In FIGS. 7 and 8, the same numbering denotes the same unit as in FIG. 6. Differences between the second embodiment of FIG. 7 and the first embodiment of FIG. 6 are that the SRS-based channel estimation unit 408 is situated in the DU 310 and not in the RU 320, and that the SRS-based channel estimation is therefore always stored in the second channel state memory 422. Other differences are that there may be a compression unit 428 at the DU 310 for compressing the stored SRS-based channel estimation before sending it over the fronthaul connection to the RU 320 and a de-compression unit 430 at the RU 320 for decompressing the received compressed SRS-based channel estimation. Differences between the third embodiment of FIG. 8 and the first embodiment of FIG. 6 are that both the SRS-based channel estimation unit 408 and the DMRS-based channel estimation unit 412 are situated in the DU 310 and not in the RU 320. For this reason, both the SRS-based channel estimation as well as the DMRS-based channel estimation are to be sent from the DU to the RU over the fronthaul connection, and possibly compressed at the DU and further decompressed at the RU.

In all FIGS. 6-8, BFWs calculated based on the obtained channel estimates are generally denoted by W. In the following description, the subscription of W will be used to specify a certain algorithm used to calculate the BFWs when necessary.

Consider a scenario with K user layers in a desired cell and J interferers from interfering cells. In antenna-element space or beam-direction space, the desired channel from target user(s) is denoted as H∈ [symbol] whereas the [symbol] interference channel from interferers is denoted as H₁ ∈ [symbol] . Transmit signals from the target users and the interferers are denoted as x∈ [symbol] and x_{I} ∈ [symbol] , respectively. The received signal at the network node, or RU in case of a distributed base station, can then be expressed as

$$y = H x + {H}_{I} {x}_{I} + n = H x + z$$

where n∈ [symbol] denotes the additive noise and z=H₁x₁+n∈ [symbol] denotes an interference-plus-noise vector.
When the signal-to-interference ratio (SIR) is high, it can be assumed that z≈n. In this case, ZF or MMSE can be used to calculate the BFWs as

$${W}_{Z F} = {( {H}^{H} H )}^{- 1} {H}^{H} \\ or \\ {W}_{MMSE} = {( {H}^{H} H + {σ}^{2} I )}^{- 1} {H}^{H}$$

respectively, where H^{H} denotes the Hermitian transpose of H, σ² is the estimated average noise power and I denotes a K×K identity matrix.

If the interferers become unneglectable, IRC achieves better performance than ZF and MMSE since it mitigates both intra-cell and inter-cell interferences. The IRC BFW matrix can be written as

$${W}_{IRC} = {{H}^{H} ( H {H}^{H} + Q )}^{- 1}$$

where Q=E{zz^{H}} is the (estimated) covariance matrix of interference-and-noise. With different implementations, the IRC BFW can be given in different formulations. For example,

$${W}_{IRC , 1} = {( {H}^{H} {Q}^{- 1} H + I )}^{- 1} {H}^{H} {Q}^{- 1} \\ or \\ {W}_{IRC , 2} = {{Λ}_{K} ( {A}^{H} A )}^{- 1} {A}^{H}$$

where A=[H G] with Q=GG^{H} and Λ_{K} denotes the first K rows of an identity matrix whose dimension is equal to the number of columns of A.

The resulted beamforming performance of the above exemplified methods for calculating BFWs relies on the accuracy of the estimation of H. For IRC, regardless of the different formulations, it also relies on the accuracy of the estimation of covariance matrix Q.

In practice, one way to estimate Q is to use residual vectors. After obtaining channel estimates Ĥ for H, a residual vector can be obtained as \hat{z}i=y_{ref,i}−Ĥx_{ref,i}, where x_{ref,i} is a reference signal and y_{ref,i} is the reference signal received at the network node, i.e., received at the RU if LLS is considered. Using L residual vectors for i=1, . . . , L, an N×L matrix can be composed as Z=1/\sqrt{L}[\hat{z}₁ . . . \hat{z}_{L}]. Note that the L residual vectors are not necessarily based on the same channel estimates. The estimation of the covariance matrix becomes \hat{Q}=ZZ^{H}. For one of the IRC formulations denoted as W_{IRC,2}, it can be G=Z. In some examples, the residual vectors can be calculated using channel estimates based on DMRS or SRS in the past time to obtain Ĥ and the incoming DMRS to obtain x_{ref,i}.

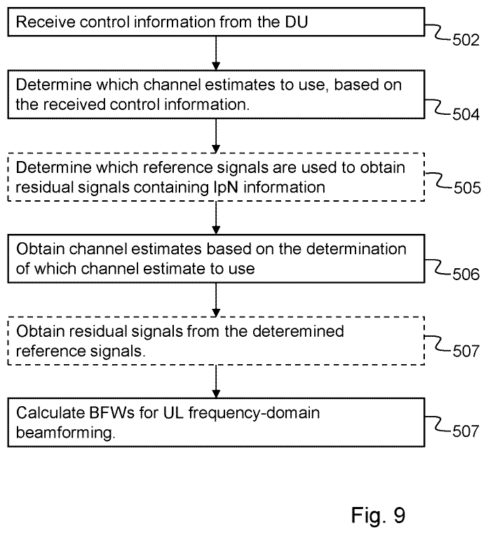

In the following, embodiments of a method of the invention is to be described with reference to FIG. 9 and in relation to a distributed base station as described in FIG. 5. Even though the embodiments are described for a distributed base station they are also applicable for a non-distributed base station/network node, such as the network node shown in FIG. 2.

So, FIG. 9, in conjunction with FIG. 5, describes a method performed by an RU 320 of a distributed base station system 300 of a wireless communication network. The distributed base station system 300 comprises the RU 320 and a DU 310 connected to the RU 320 over a fronthaul link 340. The RU is connected to N antennas 321, 322. The method comprises receiving 502 control information from the DU 310 for determining which channel estimates to use, a channel estimate determined based on the current DMRS or a channel estimate determined based on the previous reference signals, e.g., a DMRS or an SRS received in the past time. The control information may be received from a scheduler of the DU. In one embodiment, the received 502 control information comprises assisting information for the RU to decide which channel estimates to use; the channel estimates based on the current DMRS or the channel estimates based on the previous reference signals. The assisting information can be based on, but not limited to, the number of co-scheduled user-layers, the timeliness and quality of the existing channel estimates, and mobility of the wireless device sending the user layer signal. The mobility can be indicated by, for example, the estimation of Doppler shifts, the statistics of previous channel estimates, and the statistics of the wireless device reports regarding Channel State Information (CSI), e.g. Channel Quality Indicator (CQI), Reference Signal Received Power (RSRP), Reference Signal Received Quality (RSRQ), Rank Indicator (RI), Precoding Matrix Indicator (PMI)). It can for example either be an estimation of speed of the wireless device or a rough categorization of high or low mobility UE. In another embodiment, the received control information comprises indication of which channel estimates to use, based on the current DMRS or the previous reference signals, e.g., DMRS or SRS received in the past time. In some examples, it further comprises indication of which reference signals should be used for obtaining residual signals, in addition to the obtained channel estimates.

The method of FIG. 9 further comprises determining 504 which channel estimates to use for the BFW calculation of the stored channel estimates based on the previously received reference signals or channel estimates to be determined from the current DMRS. The determination 504 is performed based on the control information received 502 from the DU. In one embodiment, the determination 504 is based on the received assisting information. The determination may be based on different quality related criteria. According to one determination example, channel estimates based on the previous DMRS or SRS are used if the number of co-scheduled user layers of the UL signal is larger than a pre-defined or configured value, otherwise, the current DMRS is used for channel estimation. According to another determination example, the channel estimates based on the previous DMRS or SRS are used if the wireless device of a user layer is categorized as low mobility or the estimated UE mobility is lower than a pre-defined or configured speed value, otherwise, the current DMRS is used for channel estimation. In another embodiment, the control information received 502 from the DU comprises an indication of whether the channel estimates for BFW calculation should be based on the current DMRS or on the previous reference signals, e.g., DMRS or SRS received in the past time. In this case, the determination 504 follows the indication received in the control information DU.

The method of FIG. 9 further comprises obtaining 506 channel estimates based on the determination of which channel estimates to use, i.e. on which reference signals to base the channel estimates to be used. If the incoming/current DMRS is determined to be used, the obtaining 506 of channel estimates comprises conducting channel estimation using the incoming DMRS. In this case, the method further comprises updating channel estimates saved in the channel state memory using the newly obtained channel estimates based on the incoming DMRS. If the channel estimates based on the previous reference signals, i.e., DMRS or SRS, are determined to be used, the obtaining 506 of channel estimates comprises extracting the associated channel estimates from the channel state memory, which stores channel estimates based on the previous reference signals. In some examples, as described in FIG. 7 and FIG. 8, the existing channel estimates are received over the fronthaul from the DU and in some of those examples the channel estimates are compressed before being sent over the fronthaul, and decompressed again when received by the RU.

For certain beamforming algorithms, e.g., IRC, an estimation of interference plus noise (IpN) for the channels is also needed. In such cases, the method of FIG. 9 may further comprises a step of determining 505 which reference signals are to be used to obtain residual signals containing such IpN information. This determination 505 may as well be based on the received 502 control information. Thereafter, the residual signals are obtained 507 from the determined reference signals. A residual signal \hat{z}ᵢ can be obtained as \hat{z}ᵢ=y_{ref,i}−Ĥ(m,j)x_{ref,i}, where x_{ref,i} is a reference signal, y_{ref,i} is the reference signal received at the RU, and Ĥ(m,j) is the determined estimated channel on subcarrier m and OFDM-symbol j where the reference signal x_{ref,i} is located. In some examples, the residual signal is calculated using the current DMRS to obtain x_{ref,i} and the determined channel estimates, either based on the current DMRS or the previous reference signals, e.g., DMRS/SRS, to obtain Ĥ(m,j).

Further, the method of FIG. 9 comprises calculating 508 BFWs based on the obtained 506 channel estimates for UL frequency-domain beamforming. If the beamforming algorithm also needs the IpN estimates, calculating 508 of the BFWs is further based on the obtained 507 residual signals.

In case that the DMRS/SRS-based channel estimation is conducted in the DU, the information of the estimated channel data is sent from the DU to RU. In one embodiment, the information of estimated channel data is compressed. In one embodiment, the estimated channel is with respect to a large number of subcarriers, for example, with respect to the whole carrier bandwidth. In this option, the channel data is sent before scheduling information is available. Then the related control information, such as wireless device IDs and scheduling information can be updated regularly, for example for every slot. In another embodiment, the estimated channel is for the number of subcarriers corresponding to the bandwidth that certain wireless device(s) is/are scheduled for the next slot. As discussed before, the RU may perform an interpolation in frequency domain to get more channel estimates on the subcarriers which are included from the channel estimates sent from DU to RU.

The description above has not considered any possible phase jump between transmitter and receiver, i.e., a possible phase difference between the time of receiving previous reference signal, such as SRS or previous DMRS, and the time of receiving the data symbols of the UL signal. In the following section, phase terms of the transmitter and receiver are added to the model and the impact to the other embodiments are discussed. The effective channel is modeled as

H̅=PᵣHPₜ

where H denotes the air-interface channel, Pᵣ=diag([p_{r,1} p_{r,2} . . . p_{r,N}]) is a diagonal matrix with the k^{th} diagonal element p_{r,k} denoting the phase factor (e.g. e^{jθ}^{ₖ}) imposed to the signal by the k^{th} receiver connected to the k^{th} receive antenna, and Pₜ=diag([p_{t,1} p_{t,2} . . . p_{t,M}]) is a diagonal matrix with the k^{th} diagonal element P_{t,k} denoting the phase factor (e.g. e^{jφ}^{ₖ}) imposed to the signal by the k^{th} transmitter connected to the k^{th} transmit antenna. For UL with MU-MIMO, the transmitters can be from different UEs. Then, the received signals can be expressed as

$$y = \overline{H} x + z$$

where x denotes the transmit signals from the transmitters, and z denotes the component comprising the received interference and the receiver noise. After the beamforming at the network node, the beamformed signal can be expressed as

$$r = W \overline{H} x + {W}_{z}$$

where W denotes the beamforming matrix applied at the receiver to mitigate the interference and enhance the wanted signals.

The effective channel at time instant 0 when receiving SRS or previous DMRS is denoted as

H̅₀=P_{r,0}H₀P_{t,0}

The effective channel at time instant 1 when receiving the data symbols is denoted as

H̅₁=P_{r,1}H₁P_{t,1}

Assume the time between time instant 0 and 1 are within the coherent time, it is reasonable to assume H₀=H₁ in this analysis. Further, the receiver phases are also stable in time. In this analysis, the focus is on the difference of the transmitter phases. So, the effective channel expressions are simplified as

H̅₀=\tilde{H}P_{t,0} and H̅₁=\tilde{H}P_{t,1}

where \tilde{H}=P_{r,0}H₀=P_{r,1}H₁, since it is assumed P_{r,0}=P_{r,1} and H₀=H₁. In this analysis, the beamforming matrix W is calculated based on H̅₀ and the actual channel for the data symbols is H̅. To simplify the analysis, we focus on the WH̅₁ part and use two examples using MRC beamforming and ZF beamforming, respectively. If it works for these two examples, the same principle can be applicable to other beamforming algorithms.

For MRC beamforming, the beamforming matrix is expressed as

$$W = {\overline{H}}_{0}^{{}_{H}} = {P}_{t , 0}^{H} {\tilde{H}}^{{}_{H}}$$

Then this can be obtained

WH̅₁=P_{t,0}^{H}\tilde{H}^{H}\tilde{H}P_{t,1}

In this way, the maximum ratio combining is achieved for the air-interface channel by the term of \tilde{H}^{H}\tilde{H} in the equation. The two-phase terms P_{t,0}^{H} and P_{t,1} only contribute to an additional phase shift to each layer of the wanted signal. This additional phase shift can be compensated by an equalizer using the current DMRS signal embedded in the same slot of the data symbols.

For ZF beamforming, the beamforming matrix is expressed as

$$\begin{matrix}W = {( {\overline{H}}_{0}^{{}_{H}} {\overline{H}}_{0} )}^{- 1} {\overline{H}}_{0}^{{}_{H}} \\ = {( {P}_{t , 0}^{H} {\tilde{H}}^{{}_{H}} \tilde{H} {P}_{t , 0} )}^{- 1} {P}_{t , 0}^{H} {\tilde{H}}^{{}_{H}} \\ = {( {P}_{t , 0} )}^{- 1} {( {\tilde{H}}^{{}_{H}} \tilde{H} )}^{- 1} {( {P}_{t , 0}^{H} )}^{- 1} {P}_{t , 0}^{H} {\tilde{H}}^{{}_{H}} \\ = {( {P}_{t , 0} )}^{- 1} {( {\tilde{H}}^{{}_{H}} \tilde{H} )}^{- 1} {\tilde{H}}^{{}_{H}}\end{matrix}$$

Then this can be obtained:

$$\begin{matrix}W {\overline{H}}_{1} = {( {P}_{t , 0} )}^{- 1} {( {\tilde{H}}^{{}_{H}} \tilde{H} )}^{- 1} {\tilde{H}}^{{}_{H}} \tilde{H} {P}_{t , 1} \\ = {( {P}_{t , 0} )}^{- 1} {P}_{t , 1}\end{matrix}$$

Now it can be seen that the channels between different layers are fully cancelled by the ZF beamforming. The two-phase terms (P_{t,0})⁻¹ and P_{t,1} only contribute to an additional phase shift to each layer of the wanted signal. This additional phase shift can be compensated by an equalizer using the current DMRS signal embedded in the same slot of the data symbols.

By these two examples, it is shown that the phase jump of the transmitters at time instant 0 and 1 can be fully compensated by an equalizer at the network node using the current DMRS signal embedded in the same slot of the data symbols. It is expected that the same can be done for other beamforming algorithms. Therefore, the analysis above shows that the transmit phase jump can be handled without impacting on the performance. Such an equalizer can be an additional equalizer after the beamforming, based on the channel estimate using SRS or previous DMRS, as well as current DMRS e.g. for calculating interference and noise covariance. It can also be embedded in the beamforming functionality.

With the current functional split between O-DU and O-RU in O-RAN WG4 Open Fronthaul, embodiments of the invention may be applied in the O-DU. But in future versions of the O-RAN specifications, if it is proposed to move functionality from the O-DU to the O-RU, parts or all of some embodiments of the invention might be applied in the O-RU.

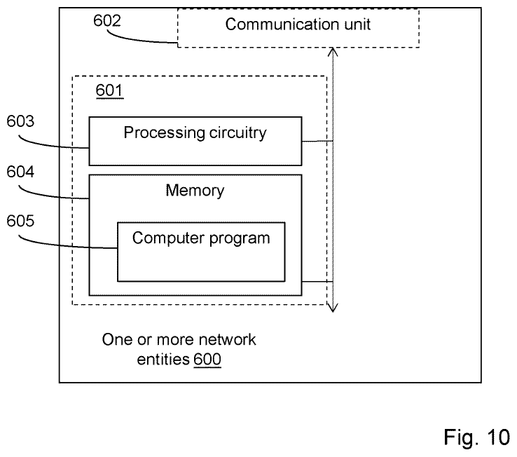

FIG. 10, in conjunction with FIG. 2, describes one or more network entities 600 configured to operate in a wireless communication network 100. The wireless communication network 100 comprises a network node 130 connected to a plurality of antennas 131, 132. The one or more network entities 600 comprises a processing circuitry 603 and a memory 604. Said memory contains instructions executable by said processing circuitry, whereby the one or more network entities 600 is operative for determining, for individual of at least one user layer signal that is received at the network node 130 in an UL signal, which UL signal comprises the at least one user layer signal of each of at least one user layer of a wireless device 140, 141 wirelessly connected to the network node 130, and a DMRS for each user layer signal, whether to use for beamforming weight calculation, a channel estimate to be determined from the received DMRS or a stored channel estimate determined from a previously received reference signal of the individual user layer. The determination is based on one or more of: one or more quality-related criterion of the stored channel estimate and one or more quality-related criterion of the channel estimate to be determined from the received DMRS. The one or more network entities 600 is further operative for determining, for individual of the at least one user layer, the channel estimate from the received DMRS, and for determining beamforming weights for frequency-domain beamforming based on the channel estimate determined from the received DMRS, when it is determined to use the channel estimate to be determined from the received DMRS. The one or more network entities 600 is further operative for obtaining, for individual of the at least one user layer, the stored channel estimate and for determining beamforming weights for frequency-domain beamforming based on the stored channel estimate, when it is determined to use the stored channel estimate. Also, the one or more network entities 600 is further operative for initiating frequency-domain beamforming of the received UL signal using the determined beamforming weights.

According to an embodiment, the one or more quality-related criterion of the stored channel estimate comprises one or more of: number of co-scheduled user layer signals when the stored channel estimate was determined, DMRS configuration when the stored channel estimate was determined in case DMRS was used then, SRS configuration when the stored channel estimate was determined in case SRS was used then, when the stored channel estimate was determined, bandwidth of the previously received reference signal, mobility of the wireless device sending the user layer signal, mobility of other wireless devices in other cells and variation of interference from other cells, and the one or more quality-related criterion of the channel estimate to be determined from the received DMRS comprises one or more of number of co-scheduled user-layer signals of the received UL signal, DMRS configuration of the received UL signal, bandwidth of the DMRS signal.

According to an embodiment, the one or more network entities 600 is operative for determining for the individual of the at least one user layer signal to use the stored channel estimate for the beamforming weight calculation when a number of co-scheduled user-layer signals of the received UL signal is higher than a number of supported orthogonal ports of the DMRS configuration of the received UL signal.

According to another embodiment, the one or more network entities 600 is operative for determining for the individual of the at least one user layer signal to use the channel estimate to be determined from the received DMRS for beamforming weight calculation when one or more of the following apply: a time difference between the receiving of the UL signal and receiving of the previously received reference signal is higher than a first threshold, and a mobility of the wireless device 140, 141 from which the user layer signal was received is higher than a second threshold.

According to another embodiment, the one or more network entities 600 is operative for determining for the individual of the at least one user layer signal to use the stored channel estimate when the number of Resource Blocks (RBs) or the number of subcarriers carrying user layer data of the user layer signal and the DMRS is smaller than a threshold.

According to another embodiment, when it is determined to use the stored channel estimate, the one or more network entities 600 is operative for determining, for individual of the at least one user layer, a residual signal for interference rejection based on the received DMRS and the stored channel estimate. Also, the one or more network entities 600 is operative for determining the beamforming weights for frequency-domain beamforming based on the determined residual signal as well as on the obtained stored channel estimate.

According to another embodiment, when it is determined to use the stored channel estimate for one of the at least one user layers, the network node is operative for compensating, after the frequency-domain beamforming of the received UL signal have been performed, for a phase shift caused by a phase difference between a previous channel which the previous reference signal experienced and a current channel which the user layer signal experiences, the phase-shift compensation being based on the beamformed DMRS of the one of the at least one user layer.

According to another embodiment, the network node is a radio unit (RU) 320 of a distributed base station system 300 comprising the RU and a distributed unit (DU) 310 connected to the RU 320 via a fronthaul connection 340. Here the one or more network entities 600 are arranged in the RU 320. The one or more network entities 600 is further operative for sending the beamformed frequency-domain UL signal to the DU 310 for demodulation and decoding of the sent beamformed UL signal at the DU.

According to an alternative of this embodiment, the one or more network entities 600 is arranged for receiving control information from the DU 310, the control information instructing the RU whether to use for the beamforming weight calculation, the channel estimate to be determined from the received DMRS or the stored channel estimate.

According to yet another embodiment, the network node is a DU 310 of a distributed base station system 300 comprising the DU and an RU 310 connected to the DU via a fronthaul connection 340. Further, the one or more network entities 600 is arranged in the DU 310.

According to other embodiments, the one or more network entities 600 may further comprise a communication unit 602, which may be considered to comprise conventional means for communication with other network nodes of the wireless communication network 100, such as other network nodes. In case the one or more network entities 600 are situated in a network node or an RU, the communication unit 602 may comprise conventional means for wireless communication with the wireless device 140, 141, such as a transceiver for wireless transmission and reception of signals in the communication network. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the one or more network entities 600 to perform the steps described in any of the described embodiments of the one or more network entities 600 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the one or more network entities 600 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by one or more network entities (600) of a wireless communication network (100), the wireless communication network comprising a network node (130) connected to a plurality of antennas (131, 132), the method comprising:
determining (204), for individual of at least one user layer signal that is received at the network node (130) in an uplink, UL, signal, which UL signal comprises the at least one user layer signal of each of at least one user layer of a wireless device (140, 141) wirelessly connected to the network node (130), and a demodulation reference signal, DMRS for each user layer signal, whether to use for beamforming weight calculation, a channel estimate to be determined from the received DMRS or a stored channel estimate determined from a previously received reference signal of the individual user layer, the determination being based on one or more of: one or more quality-related criterion of the stored channel estimate and one or more quality-related criterion of the channel estimate to be determined from the received DMRS;
for individual of the at least one user layer, when it is determined to use the channel estimate to be determined from the received DMRS, determine (206) the channel estimate from the received DMRS, and determine (208) beamforming weights for frequency-domain beamforming based on the channel estimate determined from the received DMRS,
for individual of the at least one user layer, when it is determined to use the stored channel estimate, obtain (210) the stored channel estimate and determine (212) beamforming weights for frequency-domain beamforming based on the stored channel estimate, and
initiating (214) frequency-domain beamforming of the received UL signal using the determined beamforming weights.

2. Method according to claim 1, wherein the one or more quality-related criterion of the stored channel estimate comprises one or more of: number of co-scheduled user layer signals when the stored channel estimate was determined, DMRS configuration when the stored channel estimate was determined in case DMRS was used then, SRS configuration when the stored channel estimate was determined in case SRS was used then, when the stored channel estimate was determined, bandwidth of the previously received reference signal, mobility of the wireless device sending the user layer signal, mobility of other wireless devices in other cell(s) and variation of interference from other cell(s), and the one or more quality-related criterion of the channel estimate to be determined from the received DMRS comprises one or more of number of co-scheduled user-layer signals of the received UL signal, DMRS configuration of the received UL signal, bandwidth of the DMRS signal.

3. Method according to claim 1, wherein it is determined (204) for the individual of the at least one user layer signal to use the stored channel estimate for the beamforming weight calculation when a number of co-scheduled user-layer signals of the received UL signal is higher than a number of supported orthogonal ports of the DMRS configuration of the received UL signal.

4. Method according to claim 1, wherein it is determined (204) for the individual of the at least one user layer signal to use the channel estimate to be determined from the received DMRS for beamforming weight calculation when one or more of the following apply: a time difference between the receiving of the UL signal and receiving of the previously received reference signal is higher than a first threshold, and a mobility of the wireless device (140, 141) from which the user layer signal was received is higher than a second threshold.

5. Method according to claim 1, wherein it is determined (204) for the individual of the at least one user layer signal to use the stored channel estimate when the number of Resource Blocks, RBs, or the number of subcarriers carrying user layer data of the user layer signal and the DMRS is smaller than a threshold.

6. Method according to claim 1, for individual of the at least one user layer, when it is determined to use the stored channel estimate, also determining (211) a residual signal for interference rejection based on the received DMRS and the stored channel estimate, and wherein the beamforming weights for frequency-domain beamforming are determined (212) based on the determined (211) residual signal as well as on the obtained (210) stored channel estimate.

7. Method according to claim 1, when it is determined to use the stored channel estimate for one of the at least one user layers, compensating (216), after the frequency-domain beamforming of the received UL signal have been performed (214), for a phase shift caused by a phase difference between a previous channel which the previous reference signal experienced and a current channel which the user layer signal experiences, the phase-shift compensation being based on the beamformed DMRS of the one of the at least one user layer.

8. Method according to claim 1, wherein the network node is a radio unit, RU (320) of a distributed base station system (300) comprising the RU and a distributed unit, DU (310) connected to the RU (320) via a fronthaul connection (340), and the one or more network entities (600) is arranged in the RU (320), the method further comprises, sending, by the one or more network entities, the beamformed frequency-domain UL signal to the DU (310) for demodulation and decoding of the sent beamformed UL signal at the DU.

9. Method according to claim 8, further comprising receiving control information from the DU (310), the control information instructing the RU whether to use for the beamforming weight calculation, the channel estimate to be determined from the received DMRS or the stored channel estimate.

10. Method according to claim 1, wherein the network node is a DU (310) of a distributed base station system (300) comprising the DU and an RU (310) connected to the DU via a fronthaul connection (340), and the one or more network entities (600) is arranged in the DU (310).

11. One or more network entities (600) configured to operate in a wireless communication network (100), the wireless communication network (100) comprising a network node (130) connected to a plurality of antennas (131, 132), the one or more network entities (600) comprising a processing circuitry (603) and a memory (604), said memory containing instructions executable by said processing circuitry, whereby the network node (130) is operative for:
determining, for individual of at least one user layer signal that is received at the network node (130) in an uplink, UL, signal, which UL signal comprises the at least one user layer signal of each of at least one user layer of a wireless device (140, 141) wirelessly connected to the network node (130), and a demodulation reference signal, DMRS for each user layer signal, whether to use for beamforming weight calculation, a channel estimate to be determined from the received DMRS or a stored channel estimate determined from a previously received reference signal of the individual user layer, the determination being based on one or more of: one or more quality-related criterion of the stored channel estimate and one or more quality-related criterion of the channel estimate to be determined from the received DMRS;
for individual of the at least one user layer, when it is determined to use the channel estimate to be determined from the received DMRS, determining the channel estimate from the received DMRS, and determining beamforming weights for frequency-domain beamforming based on the channel estimate determined from the received DMRS,
for individual of the at least one user layer, when it is determined to use the stored channel estimate, obtaining the stored channel estimate and determine beamforming weights for frequency-domain beamforming based on the stored channel estimate, and
initiating frequency-domain beamforming of the received UL signal using the determined beamforming weights.

12. One or more network entities (600) according to claim 11, wherein the one or more quality-related criterion of the stored channel estimate comprises one or more of: number of co-scheduled user layer signals when the stored channel estimate was determined, DMRS configuration when the stored channel estimate was determined in case DMRS was used then, SRS configuration when the stored channel estimate was determined in case SRS was used then, when the stored channel estimate was determined, bandwidth of the previously received reference signal, mobility of the wireless device sending the user layer signal, mobility of other wireless devices in other cell(s) and variation of interference from other cell(s), and the one or more quality-related criterion of the channel estimate to be determined from the received DMRS comprises one or more of number of co-scheduled user-layer signals of the received UL signal, DMRS configuration of the received UL signal, bandwidth of the DMRS signal.

13. One or more network entities (600) according to claim 11, operative for determining for the individual of the at least one user layer signal to use the stored channel estimate for the beamforming weight calculation when a number of co-scheduled user-layer signals of the received UL signal is higher than a number of supported orthogonal ports of the DMRS configuration of the received UL signal.

14. One or more network entities (600) according to claim 11, operative for determining for the individual of the at least one user layer signal to use the channel estimate to be determined from the received DMRS for beamforming weight calculation when one or more of the following apply: a time difference between the receiving of the UL signal and receiving of the previously received reference signal is higher than a first threshold, and a mobility of the wireless device (140, 141) from which the user layer signal was received is higher than a second threshold.

15. One or more network entities (600) according to claim 11, operative for determining for the individual of the at least one user layer signal to use the stored channel estimate when the number of Resource Blocks, RBs, or the number of subcarriers carrying user layer data of the user layer signal and the DMRS is smaller than a threshold.

16. One or more network entities (600) according to claim 11, for individual of the at least one user layer, when it is determined to use the stored channel estimate, the one or more network entities is operative for also determining a residual signal for interference rejection based on the received DMRS and the stored channel estimate, and the one or more network entities (600) is operative for determining the beamforming weights for frequency-domain beamforming based on the determined residual signal as well as on the obtained stored channel estimate.

17. One or more network entities (600) according to claim 11, when it is determined to use the stored channel estimate for one of the at least one user layers, the one or more network entities is operative for compensating, after the frequency-domain beamforming of the received UL signal have been performed, for a phase shift caused by a phase difference between a previous channel which the previous reference signal experienced and a current channel which the user layer signal experiences, the phase-shift compensation being based on the beamformed DMRS of the one of the at least one user layer.

18. One or more network entities (600) according to claim 11, wherein the network node is a radio unit, RU, (320) of a distributed base station system (300) comprising the RU and a distributed unit, DU, (310) connected to the RU (320) via a fronthaul connection (340), the one or more network entities (600) being arranged in the RU (320), the one or more network entities further being operative for sending the beamformed frequency-domain UL signal to the DU (310) for demodulation and decoding of the sent beamformed UL signal at the DU.

19-20. (canceled)

21. A computer program (605) comprising instructions, which, when executed by at least one processing circuitry of one or more network entities (600) of a wireless communication network (100), which wireless communication network (100) further comprises a network node (130) connected to a plurality of antennas (131, 132), causes the one or more network entities (600) to perform the following steps:
determining, for individual of at least one user layer signal that is received at the network node (130) in an UL signal, which UL signal comprises the at least one user layer signal of each of at least one user layer of a wireless device (140, 141) wirelessly connected to the network node (130), and a demodulation reference signal, DMRS for each user layer signal, whether to use for beamforming weight calculation, a channel estimate to be determined from the received DMRS or a stored channel estimate determined from a previously received reference signal of the individual user layer, the determination being based on one or more of: one or more quality-related criterion of the stored channel estimate and one or more quality-related criterion of the channel estimate to be determined from the received DMRS;
for individual of the at least one user layer, when it is determined to use the channel estimate to be determined from the received DMRS, determine the channel estimate from the received DMRS, and determine beamforming weights for frequency-domain beamforming based on the channel estimate determined from the received DMRS,
for individual of the at least one user layer, when it is determined to use the stored channel estimate, obtain the stored channel estimate and determine beamforming weights for frequency-domain beamforming based on the stored channel estimate, and
initiating frequency-domain beamforming of the received UL signal using the determined beamforming weights.

22. A carrier containing the computer program (605) according to claim 21, wherein the carrier is one of an electronic signal, an optical signal, a radio signal, an electric signal or a computer readable storage medium.
